(19) United States
(12) Patent Application Publication
(10) Pub. No.: US 2001/0037699 A1
(43) Pub. Date: Nov. 8, 2001

(54) Rolling element spacer for rolling guide device

(75) Inventors: Yasuyuki Abe, Tokyo (JP); Hiroshi Niwa, Tokyo (JP); Kentarou Nishimura, Tokyo (JP); Kiyomi Tamura, Tokyo (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: THK CO., LTD.

(21) Appl. No.: 09/836,276

(22) Filed: Apr. 18, 2001

(30) Foreign Application Priority Data
May 8, 2000 (JP) 134798/2000

(51) Int. Cl. F16H 1/24; F16H 55/02

(52) U.S. Cl. 74/424.88

(57) ABSTRACT

There is provided rolling element spacers that are used in a rolling guide device having an endless circulation path of balls and that are arranged to alternate with a multiplicity of balls and circulated in the endless circulation path along with the balls. They are constituted by a disc-shaped inner member having a pair of ball holding seats on which the balls slide in contact therewith and an annular outer member covering an outer circumferential surface of the inner member, and the outer member and inner member are molded from resin materials having different flexural modulo.

### FIELD OF THE INVENTION AND RELATED ART STATEMENT

The present invention relates to rolling element spacers interposed between balls that are adjacent to each other in an endless circulation path of various rolling guide devices such as linear guide devices and ball screw devices having an endless circulation path of balls, the spacers reducing wear and heating of such balls to cause them to roll smoothly.

Known conventional rolling guide devices in which a pair of members make a continuous relative motion with a series of balls in endless circulation interposed therebetween include linear guide devices that are used in a linear guide section of a machine tool, transport device or the like to guide a movable element such as a table on a fixed section such as a bed or saddle and ball screws that are used in combination with such a linear guide device to cause the movable element to make a stroke of linear motion in accordance with the quantity of rotation of a motor.

The linear guide device mentioned first has a track rail disposed on the fixed section and formed with a ball rolling groove in the longitudinal direction thereof, a load rolling groove that faces the rolling groove on the track rail with a multiplicity of balls interposed therebetween and a slide base formed with an endless circulation path for the balls rolling in the load rolling groove, and the device has a configuration in which the slide base that supports the movable element makes a continuous linear motion along the track rail as a result of the endless circulation of the balls. Conversely, it may have a configuration in which the track rail moves relative to a fixed slide base.

The ball screw mentioned later has a screw shaft formed with a spiral ball rolling groove with a predetermined lead, a load rolling groove that faces the ball rolling groove with a multiplicity of balls interposed therebetween and a nut member that is formed with an endless circulation path for the balls rolling in the load rolling groove, and it has a configuration in which the balls are circulated in the endless circulation path as a result of a relative rotary motion between the screw shaft and nut member and in which the nut member and the screw shaft move relative to each other in the axial direction.

In such a rolling guide device, each of the balls circulating in the endless circulation path of the balls is in mutual contact with the balls located before and after the same, in the case of high speed used, for example, and this has resulted in the possibility of problems such as relatively early wear of the balls attributable to friction between the balls and burning of the balls and load rolling groove attributable to frictional heat. Further, the arrangement of the balls is likely to become out of order in the endless circulation path when the circulating direction of the balls is reversed and, in extreme cases, this has resulted in the possibility of disablement of the operation of the rolling guide device itself as a result of the occurrence of a so-called locking phenomenon that is clogging of the balls in the endless circulation path. Under such circumstances, in order to solve such problems, Japanese unexamined patent publication No. H11-315835 has disclosed a rolling guide device in which rolling element spacers are interposed between balls that are adjacent to each other in an endless circulation path.

In the rolling guide device disclosed in the same publication, rolling element spacers referred to as “separators” made of a synthetic resin are arranged in an endless circulation path in an alternating relationship with balls to prevent the balls from contacting each other. Such a separator is formed in a disc-like configuration with an outer diameter that is smaller than the diameter of the balls, and ball holding seats having a curvature that is greater than the curvature of the spherical surface of the balls are formed on both of top and bottom sides of the separator that are in contact with the balls. When the balls and separators are thus alternately arranged in the endless circulation path without any gap between them, each of the balls is sandwiched by a pair of adjacent separators located before and after the same and is therefore circulated in the endless circulation path along with the separators without disturbing the alignment of the balls even when the circulating direction is reversed.

Such rolling element spacers are fabricated by means of injection molding of a synthetic resin or the like, and an optimum synthetic resin material can be selected from various points of view such as wear resistance against the balls and cushioning characteristics exhibited during collisions with the balls. However, the rolling element spacers are also in contact with the inner wall of the endless circulating path in the nut member in a sliding relationship because they are circulated in the endless circulation path of the nut member along with the balls. Therefore, a synthetic resin material to form the rolling element spacers must be selected in consideration not only to its relationship with the balls but also to its relationship with the endless circulation path, which results in a problem in that either of contradicting properties of such a synthetic resin material must be sacrificed for the other where both of the properties are required.

### OBJECT AND SUMMARY OF THE INVENTION

The present invention has been conceived taking such problems into consideration, and it is an object of the invention to provide a rolling element spacer that is highly satisfactory in both of suitability to balls and suitability to an endless circulation path by using a combination of different resin materials.

Specifically, according to the present invention, there is provided a rolling element spacer that is used in a rolling guide device in which a pair of members make a relative continuous motion with a series of balls in endless circulation interposed therebetween and that is interposed between balls adjacent to each other in the endless circulation path and circulated along with the balls, the rolling element spacer being characterized in that it is constituted by a disc-shaped inner member having a pair of ball holding seats that are in contact with the balls in a sliding relationship and an annular outer member covering an outer circumferential surface of the inner member and in that the outer member and the inner member are molded from resin materials having different flexural modulo.

For such a rolling element spacer according to the invention, a material to mold the inner member may be selected only in consideration to contact with the balls in a sliding relationship, and a material to mold the outer member may be selected principally in consideration to its relationship with the endless circulation path. It is therefore possible to achieve satisfactory suitability to both of the balls and endless circulation path.

The resin materials for molding the inner member and the outer member may be arbitrarily selected. For example, the flexural modulus of the resin material for molding the inner member may be greater than that of the resin material for molding the outer member and, conversely, the flexural modulus of the resin material for molding the outer member may be greater than that of the resin material for molding the inner member. Optimum materials may be selected depending on the operating environment of a ball screw device in which the rolling element spacer is used, e.g., the loading capability, the operating speed and whether a coolant is used or not.

Among such synthetic resins usable for the present invention, materials having small flexural modulo include thermoplastic elastomers, polyamide and so on, and it is preferable to use materials molded from a resin mixed with a lubricant, materials obtained by impregnating a porous resin with a lubricant, and so on from the viewpoint of lubrication of balls. Resins having great flexural modulo include materials having high durability and rigidity such as fiber-reinforced plastics and liquid crystal polymers.

From the viewpoint of rigid integration of the outer member and inner member, it is preferable to use resin materials of the same type for those members, e.g., to use a thermoplastic elastomer for the outer member when a thermoplastic elastomer is used for the inner member. The use of resin materials of the same type for the inner member and outer member results not only in preferable bonding between them but also in a small difference between their thermal expansion coefficients, which makes it possible to prevent the formation of any gap between the inner member and outer member even when the temperature of the rolling element spacer is increased by a heat attributable to the friction with the balls.

Further, in order to completely prevent the problem of dropout of the rolling element spacer from the gap between the balls adjacent to each other, the outer member is preferably formed with an annular dropout preventing section that protrudes from edges of the ball holding seats in the direction in which the balls are arranged. The dropout preventing section is configured such that it is kept out of contact with the balls seated on the ball holding seats and such that it contacts the balls only when the rolling element spacer is about to come out the gap between the balls as a result of floating of the balls above the ball holding seats.

Furthermore, by providing the dropout preventing section that protrudes from the edges of the ball holding seats in the arranging direction of the balls and that is kept out of contact with the spherical surfaces of the balls, it is possible to maintain the balls in a preferable state of lubrication because a lubricant can easily enter gaps between the dropout preventing section and the balls. Therefore, in order to maintain a lubricant for the rolling element spacer according to the invention more preferably, an annular groove is preferably formed between the ball holding seats and the dropout preventing section surrounding the same to be used as a lubricant reservoir. Such a configuration makes it possible to apply a lubricant to the surface of the balls continually because the lubricant that has entered the gaps between the balls and the dropout preventing section is retained in the annular groove.

While the dropout preventing section may be formed in a continuous annular configuration, the dropout preventing section may be provided in the form of an annular array of protrusions that are separated from each other by slits.

As thus described, the rolling element spacer according to the invention is constituted by a disc-shaped inner member having ball holding seats and an annular outer member covering an outer circumferential surface of the inner member, and the outer member and inner member are formed from resin materials having different flexural modulo. As a result, by forming the inner member and outer member using a combination of different resin materials, suitability to both of balls and an endless circulation path can be satisfied at a high degree.

### BRIEF DESCRIPTION OF THE DRAWINGS

FIG. 1 is a sectional side view of an embodiment of a ball screw device in which rolling element spacers according to the invention are arranged in an endless circulation path along with balls.

FIG. 2 is a sectional front view of the ball screw device shown in FIG. 1.

FIG. 3 is a perspective view of an example of a configuration of a rolling element spacer according to the invention.

FIG. 4 is an exploded perspective view of the rolling element spacer shown in FIG. 3 that has been disassembled into an inner member and an outer member.

FIG. 5 is a longitudinal sectional view of the rolling element spacer shown in FIG. 3.

FIG. 6 is an enlarged sectional view of the rolling element spacer shown in FIG. 3 showing the relationship between a dropout preventing section of the same and a ball.

FIG. 7 is a sectional view of the rolling element spacer shown in FIG. 3 showing a state in which balls are seated on ball holding seats.

FIG. 8 is a sectional view of the rolling element spacer shown in FIG. 3 showing a state in which the balls float above the ball holding seats.

FIG. 9 is a perspective view of another example of a configuration of a rolling element spacer according to the invention.

FIG. 10 is an exploded perspective view of the rolling element spacer shown in FIG. 9 that has been disassembled into an inner member and an outer member.

FIG. 11 is a longitudinal sectional view of the rolling element spacer shown in FIG. 9.

FIG. 12 is an enlarged sectional view showing the relationship between a dropout preventing section of the rolling element spacer shown in FIG. 9 and balls.

### Detailed Description of the Preferred Embodiments

A rolling element spacer according to the invention will now be described with reference to the accompanying drawings.

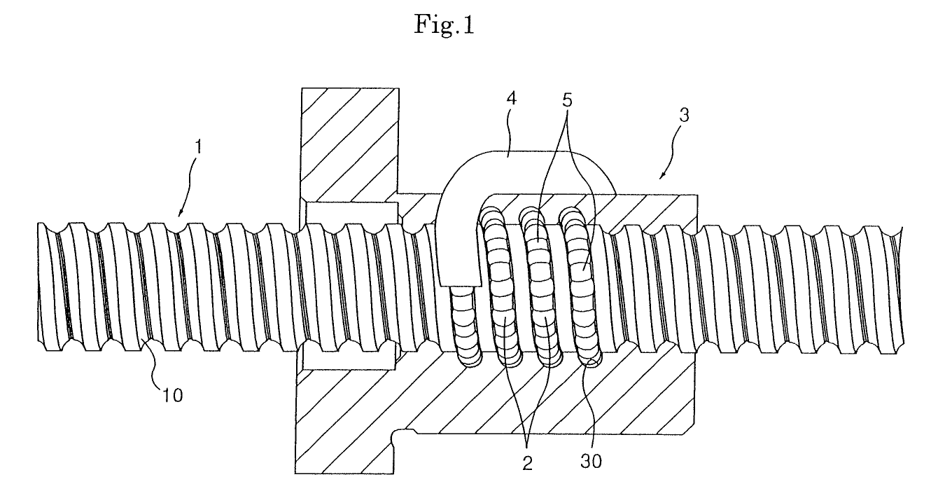

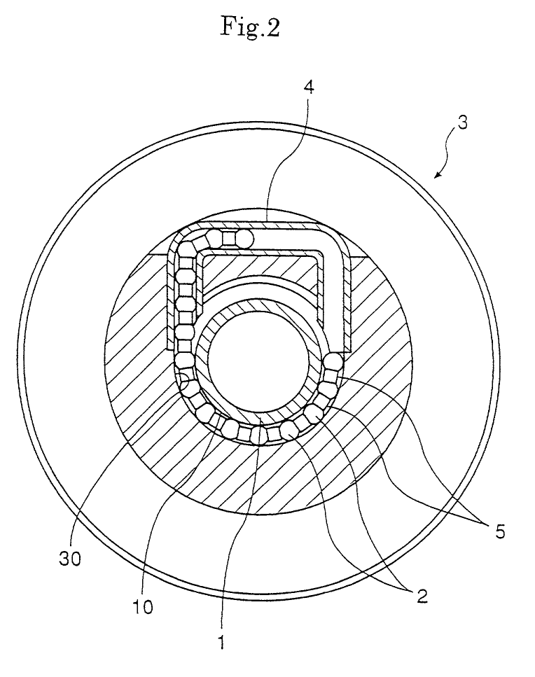

FIGS. 1 and 2 show an example of a ball screw device in which rolling element spacers according to the invention are arranged in an endless circulation path along with balls. In those figures, reference number 1 represents a screw shaft; reference number 2 represents balls; and reference number 3 represents a nut member. The nut member 3 is engaged with the screw shaft 1 through a multiplicity of balls 2.

A spiral ball rolling groove 10 is formed on the outer circumferential surface of the screw shaft 1, and a spiral load rolling groove 30 is formed on the inner circumferential surface of the nut member 3 in a face-to-face relationship with the ball rolling groove 10 on the screw shaft 1. The ball rolling groove 10 and load rolling groove 30 form a spiral load/ball path between the screw shaft 1 and nut member 3. Specifically, when a relative rotary motion occurs between the screw shaft 1 and nut member 3, the balls 2 spirally roll in the load/ball path under a certain load. The nut member 3 is equipped with a return pipe 4 that connects both ends of the load/ball path to form an endless circulation path for the balls 2 and, when the balls 2 are released from the load after rolling through the load/ball path, they roll in the return pipe 4 in an unloaded state to return to the entrance of the load/ball path jumping over several turns of the ball rolling groove 10. Therefore, when the screw shaft 1 and nut member 3 make a relative rotary motion, the balls 2 roll from the load/ball path to the return pipe 4 and then from the return pipe 4 to the load/ball path to circulate in the endless circulation path formed by the load/ball path and the return pipe 4.

In the ball screw device, in order to prevent the balls 2 incorporated in the endless circulation path from contacting each other, a rolling element spacer 5 is interposed between each pair of balls 2, 2 that are adjacent to each other.

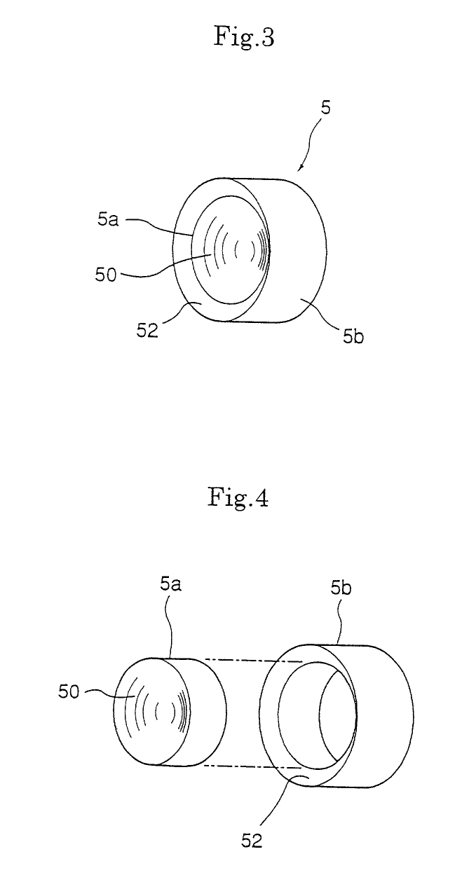

FIGS. 3 through 5 show an example of a configuration of a rolling element spacer according to the invention. A rolling element spacer 5 has an inner member 5a formed substantially in a disc-like configuration and an annular outer member 5b that covers an outer circumferential surface of the inner member 5a, and the inner member 5a and outer member 5b are unseparatably coupled. On each of top and bottom sides of the inner member 5a, there is formed a ball holding seat 50 on which a ball 2 slides in contact therewith. The balls 2 and rolling element spacers 5 are alternately arranged in the endless circulation path, which prevents mutual contact between the balls 2 that roll in the endless circulation path to allow smooth circulation of the balls 2 and consequently to allow a smoother rotary motion of the nut member 3 relative to the screw shaft 1. In addition, the generation of noises attributable to collisions between the balls can be suppressed during the operation of the ball screw device.

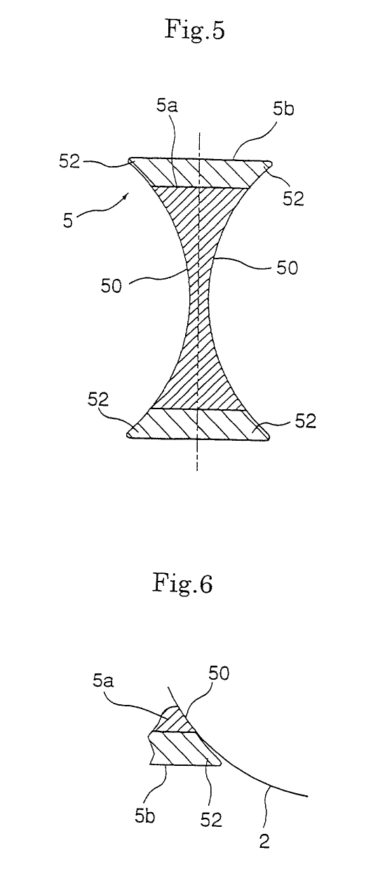

The ball holding seats 50 are formed in a concave spherical configuration that is substantially similar to the spherical surface of the ball 2 and are configured such that the balls 2 adjacent to other are put in contact with the ball holding seats 50 with substantially no gap between them. The outer member 5b is formed with an annular dropout preventing section 52 such that it surrounds the ball holding seats 50. Edges of the dropout preventing section 52 protrude from edges of the ball holding seats 50 in the direction in which the balls 2 are arranged (the lateral direction of the plane of FIG. 5). However, a gap is formed between a ball 2 and an edge of a dropout preventing section 52 when the ball 2 is seated on the ball holding seat 50, as shown in FIG. 6.

FIG. 7 shows a state in which balls 2 are seated on the ball holding seat 50 of a rolling element spacer 5 as described above. Since the ball holding seats 50 are formed in a concave spherical configuration substantially similar to the spherical surface of the balls 2 as described above, the seated balls 2 are in contact with the ball holding seats 50 with substantially no gap between them, as illustrated. Therefore, when the balls 2 and rolling element spacers 5 are arranged in the endless circulation path of the ball screw device without any gap between them, the balls 2 will never unstably shake on the ball holding seats 50 of the rolling element spacers 5, which allows the balls 2 and rolling element spacers 5 to circulate in such an endless circulation path without meandering.

Furthermore, since the dropout preventing section 52 formed around the ball holding seats 50 is not in contact with the balls 2 seated on the ball holding seats 50 and gaps having a substantially wedge-like configuration are formed between the dropout preventing section and balls, a lubricant such as grease that has stuck to the balls 2 enters the gaps. This allows the lubricant to be easily caught in the gaps between the balls 2 and ball holding seats 50 that slide on each other in contact, which makes it possible to provide reliable lubrication between the balls 2 and the rolling groove 10 of the ball screw device not only because the gaps between the balls 2 and rolling element spacers 5 can be reliably lubricated but also because the lubricant can be easily deposited on surfaces of the balls 2 that move outward after passing through such gaps.

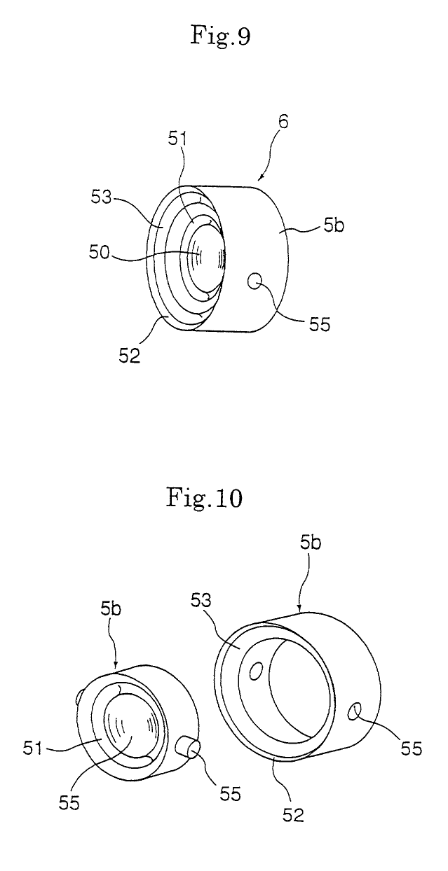

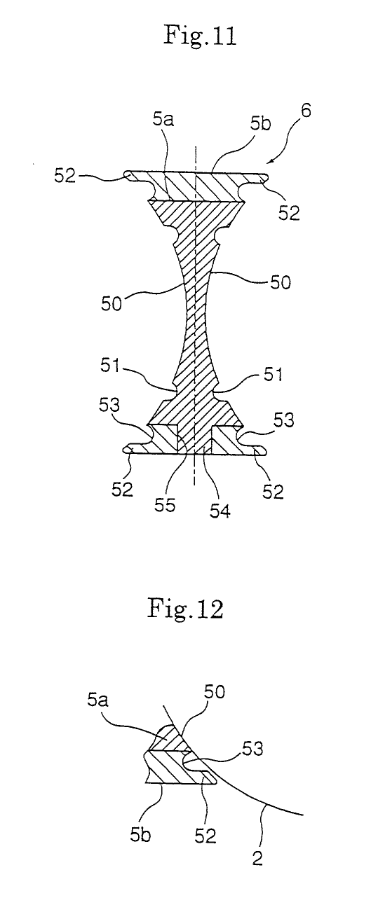

FIGS. 9 through 11 show another example of a configuration of a rolling element spacer according to the invention. A rolling element spacer 6 has a structure substantially similar to that of the rolling element spacer 5 shown in FIGS. 3 through 5, but it is different from the rolling element spacer 5 of the first embodiment in that annular lubricant reservoirs 51 are formed on the ball holding seats 50; annular grooves 53 are formed in the vicinity of the boundaries between the ball holding seats 50 and dropout preventing section 52; and the inner member 5a is formed with a locking section 54 for preventing it from parting from the outer member 5b. Therefore, features identical to those shown in FIGS. 3 through 5 will be indicated by like reference numbers in FIGS. 9 through 11 and will not be described in detail.

Both of the lubricant reservoirs 51 and annular grooves 53 are formed to provide preferable lubrication between the balls 2 and rolling element spacers 6 and to allow a lubricant to be preferably applied to the spherical surface of the balls 2. As shown in FIG. 12, in particular, by forming the annular grooves 53 at the boundaries between the ball holding seats 50 and dropout preventing section 52, a lubricant such as grease that has stuck to the balls 2 enters the annular grooves 53 through the gaps between the dropout preventing section 52 and the spherical surface of the balls 2 to stay in the annular grooves 53. This allows the lubricant to be easily caught in the gaps between the balls 2 and ball holding seats 50 that slide on each other in contact, and this makes it possible to provide reliable lubrication between the balls 2 and the rolling groove 10 of the ball screw device not only because the gaps between the balls 2 and rolling element spacers 6 can be reliably lubricated but also because the lubricant can be easily deposited on surfaces of the balls 2 that move outward after passing through the annular grooves 53.

As shown in FIG. 10, the locking section 54 protrudes from the outer circumferential surface of the inner member 5a, and the outer member 5b is formed with an anchoring hole 55 that is adapted to the locking section 54 such that the locking section 54 enters the anchoring hole 55 to integrate the outer member 5b and inner member 5a rigidly when the outer member 5b is fitted to the outer circumferential surface of the inner member 5a. While the inner member 5a and outer member 5b may be separately formed and integrated later, in order to manufacture the rolling element spacer 6 more easily, it is preferable to mold the inner member 5a on an injection molding basis with the outer member 5b formed in advance and inserted in the die.

### First Embodiment

Both of the inner member 5a and outer member 5b are formed from synthetic resins, the materials of both of them are polyester. However, while the polyester for molding the inner member 5a has a flexural modulus of 0.055 GPa, the polyester for molding the outer member 5b has a flexural modulus of 0.157 GPa. Referring to the integration of the inner member 5a and outer member 5b, while they may be separately molded in advance and thereafter integrated by means of bonding or the like, they may be integrated by molding the outer member 5b in advance and molding the inner member 5a on an injection molding basis in a die in which the outer member 5b is inserted. During the injection molding, a melted resin may be injected into the die using the anchoring hole 55 formed on the outer member 5b as a gate, and the injection molding of the inner member in such a manner allows the locking section 54 to be automatically formed in the anchoring hole 55 and makes it possible to prevent a gate cutting mark from remaining on the ball holding seats 50 of the inner member 5a. The outer member 5b is molded on an injection molding basis prior to the inner member 5a because the outer member 5b is made of a material which has a greater flexural modulus and which is harder compared to the inner member 5a. Let us assume that the inner member 5a that is softer than the outer member 5b is molded first on an injection molding basis. Then, the inner member 5a that is softer can be deformed by a pressure applied by the harder outer member 5b that is molded later, and the outer member that is harder is molded first on an injection molding basis in order to avoid such a trouble.

As an alternative combination of resin materials, the inner member may be formed from a polyester having a flexural modulus of 0.118 GPa, and the outer member may be formed from a polyester having a flexural modulus of 0.470 GPa.

In the present embodiment, since the inner member 5a formed with the ball holding seats 50 is formed from a synthetic resin having a small flexural modulus, such rolling element spacers 5 serve as a cushion between the balls 2 that are adjacent to each other, which makes it possible to suppress fatigue of the balls 2 and the generation of noises attributable to repeated collisions of the balls with the rolling element spacers 5 during circulation in the endless circulation path. Further, even when the distances between the balls 2 rolling between the nut member 3 and the screw shaft 1 under a certain load change slightly because of errors that occur during the formation of the load rolling groove 30 on the nut member 3 or the ball rolling groove 10 on the screw shaft 1, such changes in the distances can be absorbed by deformation of the inner member 5a that is formed from a soft resin material, which makes it possible to prevent the problem of clogging of the balls 2 in the endless circulation path because the balls 2 will not forcibly urge each other in the endless circulation path. In the case of a ball screw device in which such rolling element spacers 5 are arranged in an endless circulation path, this makes it possible to achieve a smooth operation with small torque fluctuations. From such a point of view, a resin material to be used for the inner member preferably has a flexural modulus in the range from about 0.05 to 0.2 GPa.

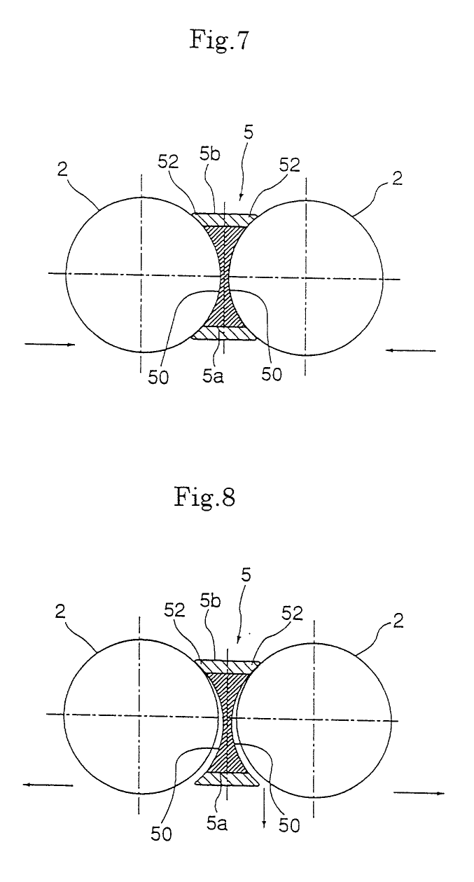

FIG. 8 shows a state in which the interval between balls 2 adjacent to each other has expanded to cause the balls 2 to float above the ball holding seats 50 of the rolling element spacer 5 during circulation in the endless circulation path. For example, such a state can occur in a certain place of an endless circulation because it is difficult to arrange the balls 2 and rolling element spacers 5 in an endless circulation path of a ball screw device without any gap between them and because the balls 2 and rolling element spacers 5 are worn after they are used for a certain period of time. When balls 2 thus float above the ball holding seats 50, the rolling element spacer 5 that has been sandwiched by the balls 2 on both sides thereof loses the support and tends to come out the gap between the balls 2. However, in the case of the rolling element spacer 5 of the present embodiment, the outer member 5b having a great flexural modulus covers the outer circumferential surface of the inner member 5a. As a result, there is an effect of preventing the rolling element spacer 5 from coming out the gap between the balls 2 even when the inner member 5a is about to come out the gap between the balls 2 due to elastic deformation of the same between the balls 2 adjacent to each other because the outer member 5b is not deformed and is caught by the spherical surface of the balls 2. In particular, in the case of the rolling element spacer 5 of the present embodiment, the dropout preventing section 52 is formed on the outer member 5b and edges of the dropout preventing section 52 protrude from edges of the ball holding seats 50 in the direction in which the balls 2 are arranged. Therefore, when the rolling element spacer 5 is about to come out the gap between balls 2 adjacent to each other, the dropout preventing section 52 that has been out of contact with the balls 2 is effectively caught by the balls 2, which provides an effect of preventing the rolling element spacer 5 from coming out the gap between the balls 2. From such a point of view, a resin material to be used for the outer member preferably has a flexural modulus in the range from about 0.15 to 2.0 GPa.

That is, the rolling element spacer 5 of the first embodiment allows smooth circulation of balls in an endless circulation path while suppressing fatigue of the balls and generation of noises after use of the same for a certain period of time. In addition, the rolling element spacer is advantageous in that the problem of dropout of the same from the gap between adjoining balls can be effectively prevented.

The flexural modulus of the outer member is preferably about three times or more and, more preferably, four times or more the flexural modulus of the inner member.

### Second Embodiment

In a second embodiment of the invention, the inner member 5a is molded from a polyester having a flexural modulus of 0.157 GPa and the outer member is molded from a polyester having a flexural modulus of 0.055 GPa, as opposed to the first embodiment. Referring to the integration of the inner member 5a and outer member 5b, they may be integrated by means of bonding or the like similarly to the first embodiment and may alternatively be integrated using injection molding. In the second embodiment, however, since the inner member has a flexural modulus greater than that of the outer member, the order of injection molding is the reverse of that in the first embodiment. Specifically, the injection molding of the inner member 5a is carried out first, and the injection molding of the outer member 5b is carried out using a die in which the inner member 5a is inserted. While the injection molding of the inner member must be performed through the anchoring hole 55 of the outer member in the first embodiment, there is no need for such a consideration according to the second embodiment because the inner member is molded prior to the outer member. This makes it possible to mold a rolling element spacer more easily at a lower cost compared to that of the first embodiment,

In the present embodiment, since the inner member 5a is formed from a synthetic resin having a great flexural modulus, in other words, a hard synthetic resin, the ball holding seats 5O of the inner member 5a will not be deformed even after repeated collisions with the balls 2. That is, the inner member 5a formed from a hard synthetic resin is excellent in dimensional stability, and it is therefore possible to prevent the rolling element spacer 5 from coming out the gap between balls 2 located before and after the same because the gaps between the ball holding seats 50 and the balls 2 are not increased even after use for a certain period of time. Further, when the inner member 5a is formed from a hard synthetic region, the ball holding seats 50 have improved anti-wear characteristics, and this also makes it possible to prevent the gaps between the ball holding seats 50 and the balls 2 from increasing as time passes. From such a point of view, a resin material to be used for the inner member preferably has a flexural modulus in the range from about 0.15 to 2.0 GPa.

Further, such a ball screw device may be exposed to a coolant when used in a machine tool, and it is expected that the rolling element spacers 5 made of synthetic resins will be swollen with the coolant. However, if a relatively hard synthetic resin is used for the inner member 5a, such swell of the inner member 5a due to the coolant is suppressed to a lower degree than that in the case of a soft synthetic resin, which makes it possible to prevent the balls 2 and rolling element spacers 5 from tightly contacting each other without any gap between them in the endless circulation path of the ball screw device. This makes it possible to avoid the problem of an increase of the torque required to rotate the screw shaft 1 with time and the problem of clogging of the balls 2 and rolling element spacers 5 in the endless circulation path.

Since a synthetic resin having a small flexural modulus or a soft synthetic resin is used for the outer member 5b in the present embodiment, for example, even when a rolling element spacer 5 is caught by a step in the endless circulation path of the ball screw device during circulation in the endless circulation path, it can be easily released as a result of elastic deformation of the outer member 5b. This makes it possible to circulate the rolling element spacers 5 and balls 2 in the endless circulation path smoothly. Further, since the toughness of the outer member 5b is improved, it is possible to prevent any damage on the outer member 5b attributable to collisions with the balls 2 and the inner wall of the endless circulation path even when the outer member 5b is formed with a small thickness. From such a point of view, a resin material to be used for the outer member preferably has a flexural modulus in the range from about 0.05 to 0.2 GPa.

The rolling element spacer 5 of the second embodiment in which the inner member 5a is formed from a resin material having a flexural modulus greater than that of the outer member 5b is advantageous in that the problem of dropout of the rolling element spacer 5 from the gap between balls 2 adjacent to each other can be effectively prevented by preventing any expansion of the gaps between the balls 2 and rolling element spacer 5 as a result of use for a certain period of time and in that the circulation of balls 2 in an endless circulation path can be made smooth by preventing the rolling element spacer 5 from being caught by a step in the endless circulation path.

What is claimed is:

1. A rolling element spacer that is used in a rolling guide device in which a pair of members make a relative continuous motion with a series of balls in endless circulation interposed therebetween and that is interposed between balls adjacent to each other in the endless circulation path and circulated along with the balls, the rolling element spacer comprising a disc-shaped inner member having a pair of ball holding seats that are in contact with the balls in a sliding relationship and an annular outer member covering an outer circumferential surface of the inner member, the outer member and the inner member being molded from resin materials having different flexural modulo.

2. A rolling element spacer according to claim 1, wherein the outer member is molded from a resin material having a flexural modulus greater than that of the inner member.

3. A rolling element spacer according to claim 1, wherein the inner member is molded from a resin material having a flexural modulus greater than that of the outer member.

4. A rolling element spacer according to claim 1, wherein the outer member and inner member are molded from resin materials of the same type.

5. A rolling element spacer according to claim 1, wherein the outer member is kept out of contact with balls seated on the ball holding seats of the inner member.

6. A rolling element spacer according to claim 5, wherein the outer member is formed with an annular dropout preventing section that protrudes from edges of the ball holding seats in the direction in which the balls are arranged.

7. A rolling element spacer according to claim 6, wherein an annular groove is formed between the ball holding seats and the dropout preventing section and wherein the annular groove serves as a lubricant reservoir.
